(19) United States
(12) Patent Application Publication
(10) Pub. No.: US 2014/0262185 A1
(43) Pub. Date: Sep. 18, 2014

(54) Heat Exchanger Containing Multiple Tubes, and Method of Making and Using Same

(71) Applicant: Turbotec Products, Inc., Windsor, CT (US)

(72) Inventor: Sunil Raina, Manchester, CT (US)

(73) Assignee: Turbotedc Products, Inc., Windsor, CT (US)

(21) Appl. No.: 13/836,486

(22) Filed: Mar. 15, 2013

(51) Int. Cl. F28F 1/10; B23P 15/26

(52) U.S. Cl. CPC F28F 1/10; B23P 15/26
USPC 165/177; 29/890.036

(57) ABSTRACT

Disclosed herein is a heat exchanger that includes a coiled outer tube, and a plurality of interlocking twisted tubes disposed within the coiled outer tube. Methods of making and using the heat exchanger also are described.

### BACKGROUND

This disclosure relates generally to heat exchangers, and more particularly to tube-in-tube heat exchangers.

Tube-in-tube heat exchangers are used in a variety of applications for transferring heat from one fluid to another. Particular configurations of tube-in-tube heat exchangers are described in U.S. Pat. Nos. 5,004,047 and 6,012,514.

It would be useful to further improve the efficiency of tube-in-tube heat exchangers, including but not limited to swimming pool heat exchangers.

### SUMMARY

One embodiment described herein is a heat exchanger comprising a coiled outer tube and a plurality of interlocking twisted tubes disposed within the coiled outer tube.

Another embodiment described herein is a heat exchanger comprising a coiled outer tube and a plurality of twisted tubes disposed in side-by-side relationship within said outer tube, said twist defining at least one thread running substantially the length of the tube, said thread defined by a peak and a valley, the peak of a given tube nesting within the valley of the other tube. In embodiments, the twisted tubes comprise titanium.

A further embodiment is a method of making a tube-in-tube heat exchanger comprising obtaining a coiled outer heat exchange tube, obtaining at least first and second twisted tubes each having an outer surface, and disposing the at least first and second twisted tubes within the outer heat exchange tube such that the second tube interlocks with the first tube. The interlocking arrangement minimizes vibration of the first and second inner tubes when a fluid flows along the outer surface of the first and second inner tubes.

Yet another embodiment is a method of using the heat exchanger described above to heat or cool a fluid.

### BRIEF DESCRIPTION OF THE DRAWINGS

FIG. 1 shows multiple views of a coiled heat exchanger of the present design. FIG. 1 is the proposed multi-tube design for which we are filing the patent;

FIG. 2 is a close-up of a multi-tube tube-in-tube heat exchanger showing the inner tubes exposed at one end;

FIG. 3 is another close-up of a multi-tube tube-in-tube heat exchanger showing the inner tubes exposed at one end;

FIG. 4 shows two views of a current design utilizing a single twisted tube within a tube-in-tube heat exchanger;

FIGS. 5A and 5B are graphs of condenser mode evaluations comparing a tube-in-tube heat exchanger containing a single inner twisted tube with a tube-in-tube heat exchanger containing two twisted inner tubes;

FIGS. 6A and 6B are graphs of evaporator mode evaluations comparing the tube-in-tube heat exchanger containing a single inner twisted tube with the tube-in-tube heat exchanger containing two twisted inner tubes; and

FIG. 7 is a chart of heat transfer comparison for the tube-in-tube heat exchanger containing a single inner twisted tube and the tube-in-tube heat exchanger containing two twisted inner tubes.

### DETAILED DESCRIPTION

Referring to the drawings, FIG. 1 shows various views of a tube-in-tube heat exchanger containing multiple interior twisted tubes. As shown in the upper view the heat exchanger 2 includes a coiled outer tube 4 in which two inner tubes 6 and 8 are located. As shown in the bottom right hand view, each of the inner tubes 6 and 8 are a twisted tube which provides a spiral thread 10 or groove extending its substantial length. There may be one or multiple spirals 10 or grooves extending along the length of the tube.

Each end of the heat exchanger is provided with a fitting 12 for inlet and outlet of the fluids. The fitting 12 includes an inlet or outlet port 14 that extends at a right-angle to the axis of the tube and which communicates with the interior of the fitting and the interior of the outer tube 4. Two inlet or outlet ports 16 and 18 extend from the body of the fitting 12 and are in communication with the interior of a respective inner twisted tube 6 or 8. In embodiments, the ports 16 and 18 are generally parallel to one another.

FIG. 2 shows an enlarged view of one end portion of the multiple tube-in-tube heat exchanger. As can be seen, each of the inner tubes 6 and 8 has a non-twisted portion 20 extending from the end of the twisted portion 22 In embodiments, the inner twisted tubes 6 and 8 comprise a titanium alloy. In embodiments, the outer tube 4 comprises a thermoplastic or thermoset material.

FIG. 3 shows an enlarged view of the end of the heat exchanger shown in the right hand view of FIG. 1. As can be seen, the inner tubes 6 and 8 are twisted and have the untwisted end portion 20 extending from the end of the twisted portion 22. The spiral thread 10 provided by the twisted tube can be defined by peaks 24 and valleys 26. As, as can be seen, the two inner tubes 6 and 8 tend to mesh or interlock with each other with the peaks 24 of one tube being at least partially received in the valley 26 of the other and visa versa. This tends to reduce vibration and relative movement between the two inner tubes. This interlocking arrangement does not reduce heat transfer efficiency, and the reduced vibration as compared to a configuration using dual smooth tubes leads to an extended useful life for the dual twisted tube arrangement.

FIG. 4 shows an example of a current single tube-in-tube heat exchanger. In this case, the heat exchanger is a single twisted tube-in-tube heat exchanger. As shown, there are two heat exchanger units 30 and 32 in side-by-side relationship interconnected together. Each unit is in coiled form. The outer tube has an inlet 34 at a right angle to the axis of a fitting 36 which connects to the interior of the outer tube through the fitting 36 which is attached to the outer tube. An inlet 38 for the inner tube is connected to the outer end of the fitting 36 which communicates with the twisted inner tube within the outer tube. The outer tubes of each unit have a spiral configuration as shown.

The outer tube of one unit 30 is connected to the outer tube of the second unit 32 by a connector tube 40 extending between the outlet 42 of the outlet fitting 44 at the end of the first unit 30 with the inlet 34 of the inlet fitting 36 of the second unit 32. The outlet fitting 44 at the end of the first unit 30 has an outlet 46 connected to the outlet coupling 44 that communicates with the inner tube.

The connector tube 40 extends from the outlet 42 of the first unit 30 to the inlet fitting 36 of the second unit 32. The inlet fitting 36 of the second unit 32 also has an inlet 38 in communication with the inner tube for connection with a source of fluid to flow to the inner twisted tube of the second unit 32. The other end of the second unit 32 has an outlet fitting 44 provided with an outlet 42 communicating with the interior of the outer tube and an outlet 46 communicating with the interior of the inner tube. This heat exchanger is an example of the type which the multi tube-in-tube heat exchange as shown in FIGS. 1-3 may be used in place of the configuration that uses only one inner twisted tube.

FIGS. 5A and 5B show graphs of the condenser mode evaluation of a tube-in-tube heat exchanger containing a single twisted tube and the tube-in-tube tube heat exchanger containing dual twisted tubes used in a high pressure side operation. The tube designated C-5844CTHVT-55 was a single twisted titanium tube within an outer tube. The tube designated 8THVT-55 contained two twisted titanium tubes inside an outer tube. In the tests, the inner tubes contained R410 refrigerant and the outer tube contained water.

From the results shown in the graphs, it can be concluded that in high pressure side operation, the use of the tube-in-tube heat exchanger containing multiple twisted inner tubes reduced the condensing mode pressure drop by one-half for the same length of heat exchanger.

FIGS. 6A and 6B show graphs of the evaporator mode evaluation of the tube-in-tube heat exchanger containing a single twisted tube and the tube-in-tube heat exchanger containing multiple twisted tubes, with both heat exchangers being used in a low pressure side operation. As in connection with the graphs of FIGS. 5A and 5B, the tube designated C-5844CTHVT-55 was a single twisted titanium tube within an outer tube, and the tube designated 8THVT-55 was two twisted titanium tubes inside an outer tube.

From the graphs of FIGS. 6A and 6B, it can be concluded that low pressure side operation showed that the use of the tube in tube heat exchanger containing multiple inner twisted tubes reduced the evaporating mode pressure drop by one-half for the same length of heat exchanger as compared to the tube-in-tube heat exchanger containing a single inner twisted tube.

FIG. 7 shows a chart comparing heat transfer area of tube-in-tube heat exchangers containing a single inner twisted tube with tube-in-tube heat exchangers containing multiple inner twisted tubes. The heat exchangers bearing the designation CTHVT-utilized a single twisted titanium tube within an outer tube. The heat exchangers bearing the designation “Multi-tube” utilized two titanium tubes inside an outer tube.

From this chart, it can be concluded that the multi-tube heat exchanger showed 200% present increase in heat transfer area. In other words, the multi-tube heat exchanger is two times more compact in size as compared to a single tube in tube heat exchanger.

A number of alternatives, modifications, variations, or improvements therein may be subsequently made by those skilled in the art, which are also intended to be encompassed by the following claims. The claims are representative and should not be construed as limiting either by broadening or narrowing scope in any application based on this application.

What is claimed is:

1. A heat exchanger comprising:
a coiled outer tube, and
a plurality of interlocking twisted tubes disposed within the coiled outer tube.

2. The heat exchanger of claim 1, wherein the outer tube comprises a thermoplastic or thermoset material and the inner tube comprises titanium.

3. The heat exchanger of claim 1, wherein there are first and second interlocking twisted tubes.

4. The heat exchanger of claim 1, further comprising:
a first fitting including:
a first inlet or outlet port that extends at a right angle to the axis of the outer tube and which communicates with an interior wall of the coiled outer tube, and
second and third inlet or outlet ports that are generally parallel to one another, the second inlet or outlet port being in communication with the first interlocking twisted tube and the third inlet or outlet port being in communication with the second interlocking twisted tube.

5. The heat exchanger of claim 4, further comprising:
a second fitting including:
a fourth inlet or outlet port that extends at a right angle to the axis of the outer tube and which communicates with an interior wall of the coiled outer tube, and
fifth and sixth inlet or outlet ports that are generally parallel to one another, the fifth inlet or outlet port being in communication with the first interlocking twisted tube and the sixth inlet or outlet port being in communication with the second interlocking twisted tube.

6. A heat exchanger comprising:
a coiled outer tube and
a plurality of twisted tubes disposed in side-by-side relationship within said outer tube, said twist defining a thread running substantially the length of the tube, said thread defined by a peak and a valley, the peak of a given tube nesting within the valley of the other tube.

7. The heat exchanger of claim 6, wherein the outer tube comprises plastic and the inner tube comprises a titanium alloy

8. The heat exchanger of claim 6, wherein there are first and second interlocking twisted tubes.

9. The heat exchanger of claim 6, further comprising:
a first fitting including:
a first inlet or outlet port that extends at a right angle to the axis of the outer tube and which communicates with an interior wall of the coiled outer tube, and
second and third inlet or outlet ports that are generally parallel to one another, the second inlet or outlet port being in communication with the first interlocking twisted tube and the third inlet or outlet port being in communication with the second interlocking twisted tube.

10. The heat exchanger of claim 9, further comprising:
a second fitting including:
a fourth inlet or outlet port that extends at a right angle to the axis of the outer tube and which communicates with an interior wall of the coiled outer tube, and
fifth and sixth inlet or outlet ports that are generally parallel to one another, the fifth inlet or outlet port being in communication with the first interlocking twisted tube and the sixth inlet or outlet port being in communication with the second interlocking twisted tube.

11. A method of making a tube-in-tube heat exchanger comprising:
obtaining a coiled outer heat exchange tube,
obtaining at least first and second twisted tubes each having an outer surface, and
disposing the at least first and second twisted tubes within the outer heat exchange tube such that the second tube interlocks with the first tube, the interlocking arrangement minimizing vibration of the first and second inner tubes when a fluid flows along the outer surface of the first and second inner tubes.

12. The method of claim 11, wherein the first and second twisted tubes comprise titanium.

13. The method of claim 11, wherein the coiled outer heat exchange tube comprises at least one of a thermoplastic and a thermoset material.

14. A method of heating or cooling a fluid using the heat exchanger of claim 1.
